(19) United States
(12) Patent Application Publication
(10) Pub. No.: US 2007/0291738 A1
(43) Pub. Date: Dec. 20, 2007

(54) Method for Controlling the Baseband Processor

(75) Inventors: Gunnar Nitsche, Radebeul (DE); Jens Bretschneider, Dresden (DE); Matthias Hofmann, Bormannsberg (DE)

Correspondence Address: HESLIN ROTHENBERG FARLEY & MESITI PC, 5 COLUMBIA CIRCLE, ALBANY, NY, 12203, US

(73) Assignee: PHILIPS SEMICONDUCTORS DRESDEN AG, DRESDEN (DE)

(21) Appl. No.: 11/568,124

(22) PCT Filed: Apr. 20, 2005
(86) PCT No.: PCT/DE05/00724

§ 371 Date: Aug. 28, 2007

(30) Foreign Application Priority Data
Apr. 29, 2004 (DE) 10 2004 021 306.2

(51) Int. Cl. H04L 12/66

(52) U.S. Cl. 370/352

(57) ABSTRACT

To control a baseband processor within a wireless network, data transmission rules are implemented in respective hosts for first and second communicants, which guarantee data transmission there between according to the rules. Data packets are communicated over electromagnetic signal paths by high frequency transceiver of a WLAN card connected to the host by a WLAN card interface. A baseband processor, on the WLAN card, prepares data packets according to the rules. The first and/or second communicants are controlled by a protocol module in the host, using hardware driver in the host, avoiding WLAN card interface. WLAN card hardware operates solely according to conditions and restrictions of a data transmission rule agreed between protocol module and baseband processor, independent of conditions and restrictions of operating system and WLAN card interface and hence, a functional region is generated in the WLAN card with hardware and software interfaces, implemented according to the rule.

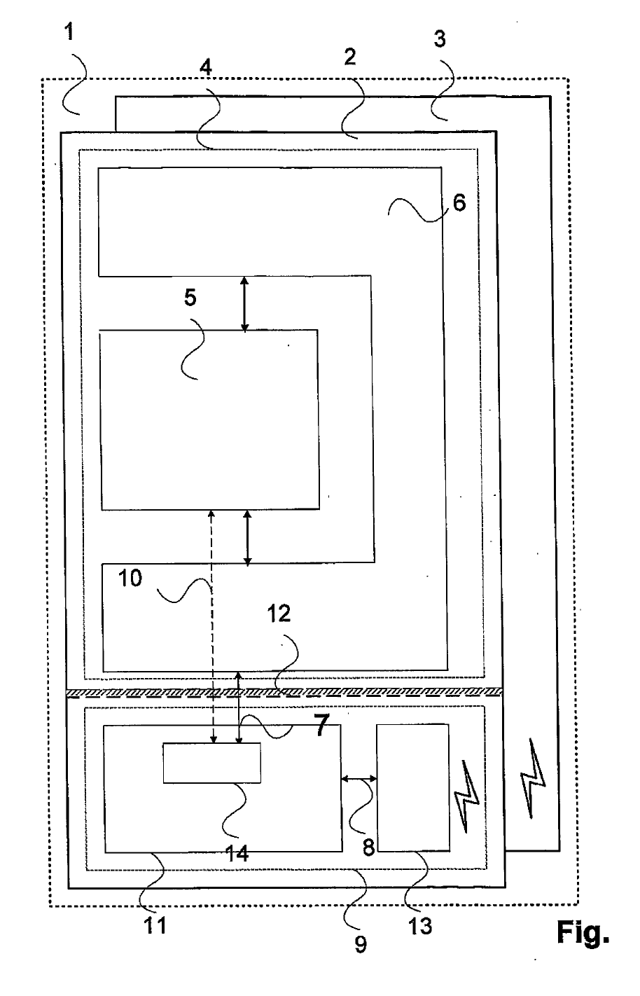

The invention concerns a method for controlling a baseband processor, whereby standardised data transmission rules are implemented in a wireless network in the respective hosts for a first and second communicant, which ensure regular data transmission between the first and second communicants of this wireless network. In this network, data packets are transmitted and/or received over electromagnetic signal paths via the HF (high frequency) transceiver unit of a WLAN card connected to the host via a WLAN interface, and whereby the baseband processor assigned to the WLAN card performs the regular processing of the data packets.

The importance of wireless networks has risen continuously in recent years; their possible fields of application appear limitless. The simplest option is configuration via two or more hosts (communicants) with wireless network cards (WLAN cards).

Each station (host) forms a so-called radio cell with its wireless network card. This corresponds to the range covered by each radio. Such a configuration is referred to in the simplest case as a basic service set (BSS).

As long as several mobile stations (hosts) are located in a collective cell or overlap their cells, communication between them is possible. Therefore a hub or switch is not essential (ad hoc network).

If you want to connect the wireless network (WAN) to a wired network (LAN), an access point (AP) is required. Such a network structure is also referred to as a distribution system (DS).

In this way, an access point also forms a radio cell with at least one individual station. Increasing the range of individual stations and access points is achieved by additional cells. In doing so, the access point acts as a classic network bridge.

The high data rates of wired local networks have yet to be achieved by wireless networks, but the latter are being increased further and are approaching the level of the wired local networks.

In addition to the existing technical-based problems of wireless networks (inc. intersymbol interference caused by multipath propagation of the send signal), further problems arise with the use of such networks compared with wired networks, due to the fact that several processes are in competition on the WLAN product market.

Although the IEEE (Institute of Electrical and Electronics Engineers) already laid the foundations for WLANs in 1997 with the 802.11 standard, users and network operators also use other wireless systems, e.g. such systems that function in accordance with HiperLAN/2 and that are standardised according to the ETSI (European Telecommunications Standards Institute).

With the development of WLAN technology, both these standards have overwhelmingly established themselves with regard to the level of technology. Consequently, the variety of communication modes that must be taken into account for the communication of user-defined wireless networks is restricted. Despite this, their number is significant.

In accordance with their status as normal LANs, the WLANS that are specified with regard to the rules for wireless networks as per standard IEEE 802.11 but also as per standard HiperLAN/2 are part of the familiar 802 definitions for local networks.

As with the standards for LANs, the WLAN standards are specified at the lowest two layers of the seven layers comprising the open system interconnect (OSI) model.

In addition, the management functions required by the IEEE have been described for the two lowest layers for the stations or new sublayers have been developed.

Both standards allow for a similar wireless interface, which is correspondingly located in a first layer, the physical layer.

However, there is a fundamental difference between the two standards with regard to the access method used, which is defined for the higher-level second layer, the medium access control (MAC) layer. The MAC layer performs typical functions that are otherwise located in higher layers: fragmenting, data packet repetition and the confirmation of data packets.

It is important for low-cost WLAN products that they operate in publicly accessible frequency ranges.

As a result, WLAN operators do not first have to acquire a licence to operate their system, as is the case with mobile communication systems. They use ISM (industrial, scientific and medical) frequency bands, which are approved up to a certain transmitting power. These frequency bands are in the 2.4 GHz range, which is used by 802.11 WLAN and Bluetooth, for example, or in the 5 GHz band.

Although this licence-free use reduces costs, it also means that the many systems permitted to work in these bands interfere with each other.

This considerable mutual interference has a further disadvantage in that additional technical expenditure cannot be avoided.

Yet another drawback created by the licence-free use of these ISM bands is that although they share similar designs around the world, they do not entirely coincide.

Not only are different frequency bands prescribed in different countries, various limits apply for the relevant transmitting power where ISM frequency bands are concerned. The various measures to offset or avoid the above disadvantages make it hard for hardware producers to create a standardised product that can be marketed worldwide.

As well as the relatively high prices, the other factor preventing a wider distribution of WLAN products is the insufficient availability of small mobile and adequately fast universal WLAN cards, which can be used to simply equip every host for the communicants in the WLAN and ensure interoperability in different wireless networks.

From a technical and economic viewpoint, it would not be viable to simultaneously implement different systems in the WLAN units that take into account the various communication modes to be deployed.

A more cost-effective way of improving the efficiency of wireless networks that is emerging with the level of technology as it stands is the property of reconfigurability. This makes it possible to adapt the radio interfaces involved in the data transmission to the required quality of service and transmission situation of the existing infrastructure networks.

Another method presented by current technology is the use of downloadable protocols, whereby the end devices automatically collect the protocols required for the situation from the access point.

Although baseband processors are now providing the necessary signals for data exchange in the WLAN units, such universal WLAN communicants can only be implemented to a limited degree, mainly because a baseband processor is normally controlled by the direct access of the host using its software on the hardware register of the processor circuit.

The transmission data are processed for interlinked lists, and the address of the list start is stored directly in the baseband processor. The baseband processor could only be programmed together with the specific adjustment of the hardware of the WLAN communicants. An example of this is the TI ThunderLAN PCI Ethernet Controller SPWS018B.

From this, it is evident that as the software is strongly tailored to the hardware used, the WLAN units along with their drivers and protocol software must have accurate knowledge about the quality of the hardware used, such as registers etc.

With the current level of technology, the disadvantage remains that a distributed system is required for the realisation of WLAN networks with standard WLAN products, especially those the routines of which improve transmission performance in the data communication in accordance with the standards of IEEE 802.11 but also other WLAN standards such as HiperLAN/2. With its interaction, this system is dependent on the WLAN hardware with its supported media access control (MAC) functionalities (layer 2 of the OSI layer model), depending on the device, the operating system used (stack and driver) of the end devices, and partly also on the relevant access point.

The creative challenge therefore lies in implementing different standardised WLAN units on a platform-independent basis in terms of the hardware used and operating system applied.

This challenge is solved by controlling the first and/or second communicants via a protocol module implemented in the relevant host by means of the hardware driver also implemented in the relevant host, avoiding the WLAN card interface, the hardware of the connected WLAN card operating solely according to the conditions and restrictions of a data transmission rule agreed between the protocol module and the baseband processor, independently of the conditions and restrictions of the operating system and the WLAN card interface.

This generates a functional area in the WLAN card with a software interface implemented in accordance with the data transmission rule and with a hardware interface.

The objective of this solution is to enable the protocol software to be used for different chip versions without any significant change. The use of the hardware driver is possible for various applications without any major change. In addition, the protocol module is implemented in such a way that it does not feature any operating system details.

Furthermore, the method can be applied independently of the hardware interfaces between host and baseband processor.

One version of the method provides for the functional area to be equipped so that the relevant data transmission function is interpreted in it. The communicating interface of the baseband processor is controlled via the software interface of the functional area so that a baseband signal is provided by the baseband processor ensuring the data transmission via an HF transceiver unit of the WLAN card.

In a second version, if there is a change to the data transmission function determined by the relevant host for the WLAN card during the operating condition of the first and/or second communicant, this new data transmission function of the WLAN card is executed in the same way as with the receipt of the original operating condition.

Under one variation of the second version, the initialisation and change to the data transmission function for the WLAN card each run in the same way, regardless of whether the implemented data transmission rules map standards. Here, standards can apply according to IEEE 802.11 or HiperLAN/2, for example.

Under a special variation of the second version, the interface of the baseband processor communicating with the software interface of the functional area is executed as a 16-bit FIFO stack.

The invention should subsequently be explained in greater detail using an execution example.

In the attached drawing FIGURE, the layout of a WLAN 1 is shown in a block diagram with first and second communicants 2 and 3.

As can be seen in the drawing FIGURE, protocol module 5 and hardware driver 6 are implemented in host 4 of the first communicant 2.

Host 4 is connected to WLAN card 9 via a LAN card interface 12. WLAN card 9 is provided with baseband processor 11 and the connected HF unit 13. The physically shared connection conditions of baseband processor 11 and HF transceiver unit 13 should be realised by hardware interface 8.

The software conditions, which must be taken into account for the data exchange on the one hand by hardware driver 6 and on the other by baseband processor 11, and thus also by the functional area 14 to be created, should be regarded as agreed by software interface 7.

This software interface 7 is typically formed by both functions for transmitting and receiving the data transmission rule 10 (protocol).

The protocol module 5 implemented in host 4 thus controls the first communicant 2, in which hardware driver 6 is used over WLAN card interface 12 to control the hardware of the connected WLAN card 9 exclusively in accordance with the conditions and restrictions of an agreed data transmission rule 10 between protocol module 5 and baseband processor 11.

This control is performed independently of the conditions and restrictions of the operating system in host 4 and of the realised WLAN card interface 12.

During control, data transmission function 10 is identified in WLAN card 9 in baseband processor 11, and in an execution phase, functional area 14 is created with software interface 7, which is implemented in accordance with data transmission rule 10.

Functional area 14 is equipped so that the interpretation in the relevant data transmission function 10 is that the communicating interface of baseband processor 11 is controlled via software interface 7 of functional area 14 in such a way that an associated baseband signal is provided by baseband processor 11. This signal ensures the data transmission by means of an HF transceiver unit 13 of WLAN card 9. The communicating interface of baseband processor 11 is thereby typically executed as a 16-bit FIFO stack.

After the execution phase, its termination is confirmed to hardware driver 6. The latter passes on this confirmation to protocol module 5, so that the adjusted radio channel can now be used in WLAN 1.

### LIST OF NUMERALS

1 WLAN (Wireless Local Area Network)
2 First communicant
3 Second communicant
4 Host
5 Protocol module (implemented data transmission rules)
6 Hardware driver
7 Software interface
8 Hardware interface
9 WLAN card
10 Data transmission function (stored in the functional area)
11 Baseband processor
12 LAN card interface (standardised in accordance with PCI, USB)
13 HF transceiver unit
14 Functional area

1. Method for controlling a baseband processor, wherein standardised data transmission rules are implemented in a wireless network in respective hosts for first and second communicants, which ensure regular data transmission between the first and second communicants of the wireless network, and data packets are transmitted and/or received over electromagnetic signal paths via a HF (high frequency) transceiver unit of a WLAN card connected to a relevent host via a WLAN interface, and a baseband processor assigned to the WLAN card performs the regular processing of the data packets, comprising controlling of the first and/or second communicants by a protocol module implemented in the relevant host by a hardware driver also implemented in the relevant host, avoiding the WLAN card interface, hardware of the connected WLAN card operating solely according to conditions and restrictions of a data transmission rule agreed between the protocol module and the baseband processor, independently of conditions and restrictions of an operating system and the WLAN card interface, which generates a functional area in the WLAN card with a software interface implemented in accordance with the data transmission rule and with a hardware interface.

2. Method in accordance with claim 1, wherein the functional area is equipped so that the data transmission rule is interpreted in the functional area, and a communicating interface of the baseband processor is controlled via the software interface of the functional area, so that a baseband signal is provided by the baseband processor ensuring the data transmission via a high-frequency transceiver unit of the WLAN card.

3. Method in accordance with claim 1, wherein in the event of a change to the data transmission rule determined by the relevant host for the WLAN card during operating condition of the first and/or second communicant, the resulting new data transmission rule of the WLAN card is executed in same way as with receipt of original operating condition for the WLAN card.

4. Method in accordance with claim 1, wherein initialisation and change to the data transmission rule for the WLAN card are carried out in same way, regardless of whether implemented data transmission rules map standards.

5. Method in accordance with claim 1, wherein the interface of the baseband processor communicating with the software interface of the functional area is executed as a 16-bit FIFO stack.
